(19) United States
(12) Patent Application Publication
(10) Pub. No.: US 2006/0217922 A1
(43) Pub. Date: Sep. 28, 2006

(54) System and method for examining component/accessory assembly of product

(75) Inventors: Shoui-Liang Wong, Taipei (TW); Shan-Fa Shih, Taipei (TW); Po-Wen Lu, Taipei (TW); Min-Tzu Sung, Taipei (TW); Yi-Te Wang, Taipei (TW); Ming-Yuan Chien, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/076,614

(22) Filed: Mar. 8, 2005

(51) Int. Cl. G01G 9/00

(52) U.S. Cl. 702/173

(57) ABSTRACT

A system and a method for examining component/accessory assembly of a product are provided for allowing a user to determine whether there are omitted or extra added components/accessories for a product ready for output. The system includes a product database for storing product related information such as product name, product weight and so on; a data input module for allowing the user to input the product related information such as product number and so on; a measuring module for measuring an actual weight of the product; a calculating module for calculating a value of difference between the actual weight and a standard weight of the product; a data accessing module for storing the standard weight and the actual weight of the product into the product database; and a data display module for displaying a warning message if the value of difference for the product exceeds a predetermined value range.

### FIELD OF THE INVENTION

The present invention relates to systems and methods for examining component/accessory assembly of products, and more particularly, to a system and method for sending a warning message for a product having a value of difference between an actual weight and a standard weight thereof beyond a predetermined value range.

### BACKGROUND OF THE INVENTION

Quality control is usually a difficult but important task for manufacturers, especially in fabricating an information communication product such as a mobile phone, personal computer, personal digital assistant (PDA) and so on. This is because the information communication product contains many components and associated accessories, making it easy to omit or extra add some of the components and accessories when assembling the product, and thereby affecting quality of the fabricated product. Further as the information communication product contains many types of components and accessories, performing the conventional quality control process thereon is time- and labor-consuming, and is not easy to detect omission or extra addition of the components and accessories, making quality control for such information communication product relatively more difficult to implement.

However, the level of product quality control affects not only the quality of fabricated products but also the reputation of manufacturers. Therefore, the problem to be solved here is to provide a simple and efficient quality control method so as to improve the quality control of information communication products.

### SUMMARY OF THE INVENTION

In light of the foregoing drawbacks in the prior art, a primary objective of the present invention is to provide a system and method for examining component/accessory assembly of a product, which can calculate a value of difference between an actual weight of a product and a standard weight thereof stored in a product database, and send a warning message to a user if the value of difference exceeds a predetermined value range so as to allow the user to reexamine the product and determine whether there are omitted or extra added components/accessories for the product, such that an abnormally operating machine assembling improper products can be stopped to prevent further omission or extra addition of components/accessories from affecting quality of fabricated products.

In order to achieve the above and other objectives, the present invention proposes a system for examining component/accessory assembly of a product, comprising: a product database for storing product related information such as product number, product name, standard weight of single product, accessory name, accessory weight, standard weight of finished product, actual weight of combination of pallet and finished products carried thereon, and so on; a data input module for allowing a user to establish the product database and input the product related information such as product number and so on; a measuring module for measuring an actual weight of single product, an actual weight of finished product and an actual weight of combination of pallet and finished products carried thereon for a product; a calculating module for calculating a standard weight of finished product for the product, and calculating a value of difference between an actual weight and a standard weight of the product; a data accessing module for storing the standard weight of finished product calculated by the calculating module and the actual weight of combination of pallet and finished products carried thereon measured by the measuring module into the product database; and a data display module for displaying a warning message if the value of difference for the product exceeds a predetermined value range so as to allow the user to reexamine the product and determine whether there are omitted or extra added components/accessories for the product.

The present invention also proposes a method for examining component/accessory assembly of a product. Firstly, product related information such as product number, product name, accessory name, accessory weight and so on is stored into a product database for allowing a user to calculate a standard weight of a product. Next, a standard weight of single product is measured for the product and is stored into the product database, wherein the standard weight of single product represents a weight of a single product that is properly assembled with standard components. A standard weight of finished product is calculated for the product and is stored into the product database. Subsequently, an actual weight of single product is measured for the product, and a value of difference between the actual weight of single product and the standard weight of single product is calculated for the product, wherein if the value of difference exceeds a predetermined value range, a warning message is displayed. Then, an actual weight of finished product is measured for the product, and a value of difference between the actual weight of finished product and the standard weight of finished product is calculated for the product, wherein if the value of difference exceeds a predetermined value range, another warning message is displayed. Finally, an actual weight of combination pallet and finished products carried thereon is measured for the product, and is stored into the product database for allowing the user to search data.

Therefore, by the system and method for examining component/accessory assembly of a product, firstly, product related information is stored into the product database. Then, the measuring module measures a standard weight of single product for a product wherein the standard weight of single product represents a weight of single product that is properly assembled with standard components, and the calculating module calculates a standard weight of finished product for the product, such that the standard weights are stored into the product database. Next, the measuring module measures an actual weight of single product and an actual weight of finished product for the product, and the calculating module calculates a value of difference between the actual weight and standard weight of single product and a value of difference between the actual weight and standard weight of finished product. Finally, the data display module displays a warning message if either one of the values of difference exceeds a predetermined value range, such that a user can reexamine the product to determine whether there are omitted or extra added components/accessories for the product, and an abnormally operating machine assembling improper products can be stopped.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing basic architecture of a system for examining component/accessory assembly of a product according to the present invention;

FIG. 2 is a flowchart showing steps of a method for examining component/accessory assembly of a product according to the present invention; and

FIG. 3 is a flowchart showing detailed procedures for establishing a product database by the method for examining component/accessory assembly of a product according to the present invention.

### DETAILED DESCRIPTION OF THE PREFFERED EMBODIMENTS

Preferred embodiments below are used to describe a system and method for examining component/accessory assembly of a product proposed in the present invention in detail but not for setting a limitation on the scope of the present invention.

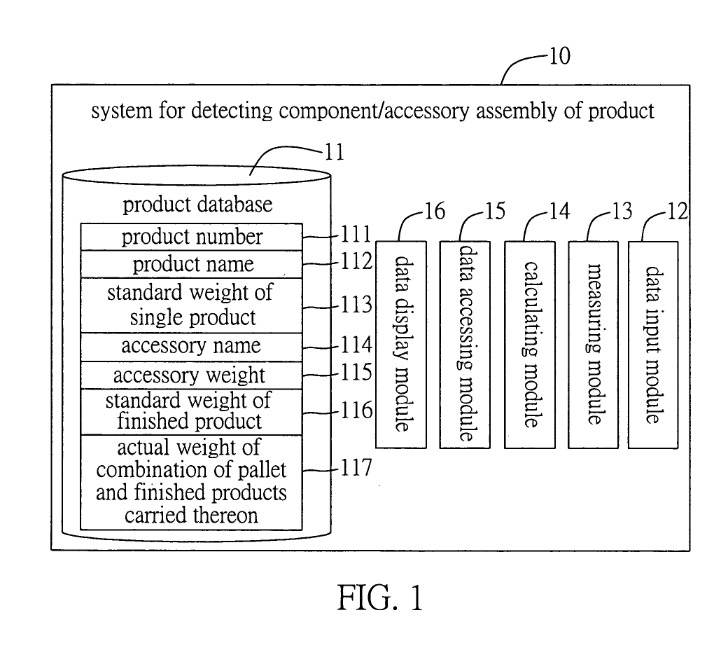

FIG. 1 is a block diagram showing basic architecture of the system for examining component/accessory assembly of a product according to the present invention. As shown in FIG. 1, the system for examining component/accessory assembly of a product in the present invention includes a product database 11, a data input module 12, a measuring module 13, a calculating module 14, a data accessing module 15, and a data display module 16.

The product database 11 is used to store product related information such as product number 111, product name 112, standard weight of single product 113, accessory name 114, accessory weight 115, standard weight of finished product 116, actual weight of combination of pallet and finished products carried thereon 117, and so on, so as to allow a user to calculate a standard weight of a product and a value of difference between the standard weight and an actual weight of the product. The standard weight of single product refers to a standard weight of main components of a product (such as a main body of a computer or mobile phone). The standard weight of finished product refers to a standard weight of the sum of the main components and associated accessories (such as power lines, batteries and so on of the computer or mobile phone) of the product when being ready for output. The actual weight of combination of pallet and finished products carried thereon refers to a measured weight of the sum of a pallet and finished products that can be carried on the whole pallet.

The data input module 12 is used for the user to establish the product database 11 and input the product related information such as product number and so on, such that corresponding product data for the inputted product number can be searched in the product database 11.

The measuring module 13 is used to measure an actual weight of single product, an actual weight of finished product and an actual weight of combination of pallet and finished products carried thereon 117 for the product, so as to allow the user to compare the actual weights and the corresponding standard weights stored in the product database to calculate values of differences therebetween. The actual weight of single product refers to a measured weight of main components of a product (such as a main body of a computer or mobile phone). The actual weight of finished product refers to a measured weight of the sum of the main components and associated accessories (such as power lines, batteries and so on of the computer or mobile phone) of the product when being ready for output. The actual weight of combination of pallet and finished products carried thereon refers to a measured weight of the sum of a pallet and finished products that can be carried on the whole pallet.

The calculating module 14 is used to read the standard weight of single product 113 and the accessory weight 115 corresponding to the product from the product database 11, and calculates the standard weight of finished product 116 for the product by a formula: Standard weight of finished product=Standard weight of single product+Accessory weight. Moreover, the calculating module 14 also allows the user to calculate a value of difference between the actual weight of the product and the standard weight thereof stored in the product database 11.

The data accessing module 15 is used to store the standard weight of finished product 116 calculated by the calculating module 14 into the product database 11, such that the calculating module 14 can calculate a value of difference between the actual weight and the standard weight of the product. The data accessing module 15 is also used to store the actual weight of combination of pallet and finished products carried thereon 117 measured by the measuring module 13 into the product database 11.

The display module 16 is used to send a warning message if the value of difference calculated by the calculating module 14 exceeds a predetermined value range that is set by the user according to characteristics of the product, such that the user can reexamine the product to determine whether there are omitted or extra added components/accessories for the product.

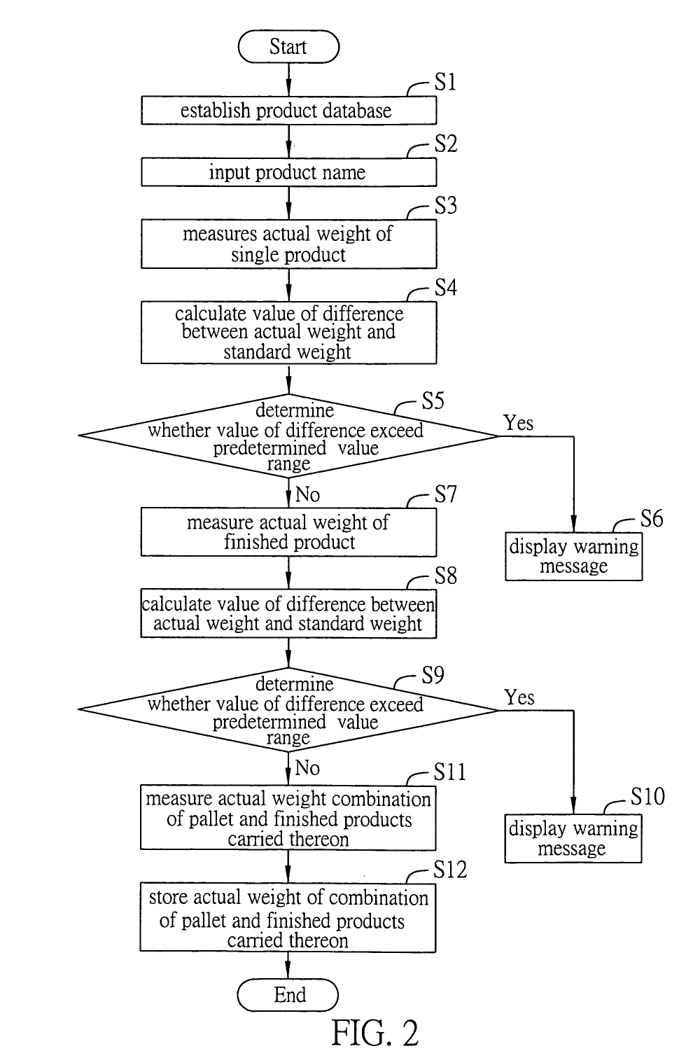

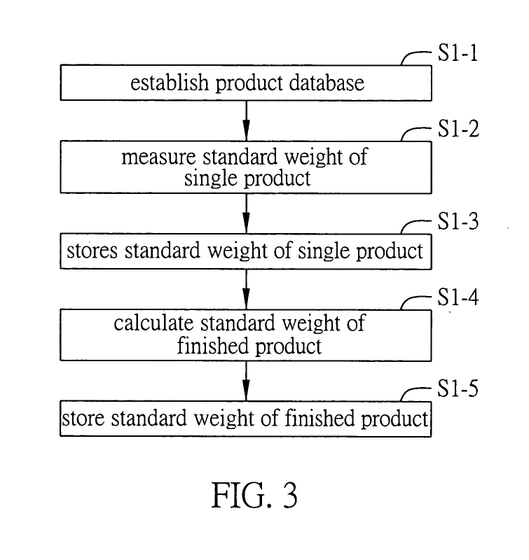

FIG. 2 is a flowchart showing steps of a method for examining component/accessory assembly of a product according to the present invention. As shown in FIG. 2, firstly, in step S1, a product database 11 is established; detailed procedures of establishing the product database 11 are shown in FIG. 3. Then, the method proceeds to step S2.

In step S2, a product number 111 of a product is inputted via a data input module 12, and a data accessing module 15 reads corresponding product related information such as standard weight of single product 113, standard weight of finished product 116 and so on from the product database 11 according to the product number 111. Then, the method proceeds to step S3.

In step S3, a measuring module 13 measures an actual weight of single product for the product. Then, the method proceeds to step S4.

In step S4, a calculating module 14 calculates a value of difference between the actual weight of single product for the product and the corresponding standard weight of single product 113 stored in the product database 11. Then, the method proceeds to step S5.

In step S5, the calculating module 14 determines whether the value of difference from step S4 exceeds a predetermined value range. If it exceeds the predetermined value range, the method proceeds to step S6. If it does not exceed the predetermined value range, the method proceeds to step S7.

In step S6, a data display module 16 displays a warning message to inform a user that there may be omitted or extra added components for the product.

In step S7, the measuring module 13 measures an actual weight of finished product for the product. Then, the method proceeds to step S8.

In step S8, the calculating module 14 calculates a value of difference between the actual weight of finished product for the product and the corresponding standard weight of finished product 116 stored in the product database 11. Then, the method proceeds to step S9.

In step S9, the calculating module 14 determines whether the value of difference from step S8 exceeds a predetermined value range. If it exceeds the predetermined value range, the method proceeds to step S10 where the data display module 16 displays a warning message to inform the user that there may be omitted or extra added accessories for the product. If the value of difference from step S8 does not exceed the predetermined value range, the method proceeds to step S11.

In step S11, the measuring module 13 measures an actual weight of pallet and finished products carried thereon 117. Then, the method proceeds to step S12.

In step S12, the data accessing module 15 stores the actual weight of pallet and finished products carried thereon 117 into the product database 11 to allow the user to search data.

FIG. 3 is a flowchart showing detailed procedures of step S1 in FIG. 2 for establishing data files in the product database 11. As shown in FIG. 3, firstly, in step S1-1, product related information such as product number 111, product name 112, accessory name 114, accessory weight 115 and so on is stored into the product database 11 so as to allow a user to calculate a standard weight of a product and a value of difference between an actual weight and the standard weight of the product. Then, it proceeds to step S1-2.

In step S1-2, the measuring module 13 measures a weight of single product for a standard product. The standard product refers to a product successfully passing the quality control examination and is properly assembled with standard components. The weight of single product refers to a standard weight of main components (such as a main body of a computer or mobile phone) of the standard product. Then, it proceeds to step S1-3.

In step S1-3, the data accessing module 15 stores the weight of single product into the product database 11 as a standard weight of single product 113. Then, it proceeds to step S1-4.

In step S1-4, the data accessing module 15 reads the standard weight of single product 113 and the accessory weight 115 for a product from the product database 11, and the calculating module 14 calculates a standard weight of finished product 116 for the product according to a formula: Standard weight of single product+Accessory weight=Standard weight of finished product. The standard weight of finished product refers to a standard weight of the sum of the main components and associated accessories (such as power lines, batteries and so on of the computer or mobile phone) of the product when being ready for output. Then, it proceeds to step S1-5.

In step S1-5, the data accessing module 15 stores the standard weight of finished product 116 into the product database 11.

Therefore, by the system and method for examining component/accessory assembly of a product, firstly, product related information is stored into the product database. Then, the measuring module measures a standard weight of single product for a product wherein the standard weight of single product represents a weight of a single product that is properly assembled with standard components, and the calculating module calculates a standard weight of finished product for the product, such that the standard weights are stored into the product database. Next, the measuring module measures an actual weight of single product and an actual weight of finished product for the product, and the calculating module calculates a value of difference between the actual weight and standard weight of single product and a value of difference between the actual weight and standard weight of finished product. Finally, the data display module displays a warning message if either one of the values of difference exceeds a predetermined value range, such that a user can reexamine the product to determine whether there are omitted or extra added components/accessories for the product, and an abnormally operating machine assembling improper products can be stopped.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A system for examining component/accessory assembly of a product, comprising:
a product database for storing product related information comprising a standard weight of the product;
a measuring module for measuring an actual weight of the product;
a calculating module for calculating a value of difference between the standard weight of the product stored in the product database and the actual weight of the product measured by the measuring module; and
a data display module for displaying a warning message if the value of difference for the product exceeds a predetermined value range set by a user.

2. The system of claim 1, further comprising a data accessing module for storing the standard weight of the product into the product database.

3. The system of claim 1, wherein the product related information further comprises product number, standard weight of single product, and accessory weight.

4. The system of claim 3, wherein the standard weight of the product comprises at least one of the standard weight of single product and a standard weight of finished product, and the standard weight of finished product represents the sum of the standard weight of single product and the accessory weight.

5. The system of claim 1, wherein the actual weight of the product comprises at least one of an actual weight of single product and an actual weight of finished product.

6. (canceled)

7. A method for examining component/accessory assembly of a product, comprising the steps of:
storing product related information comprising a standard weight of the product into a product database;
measuring an actual weight of the product;
obtaining the standard weight of the product from the product database to calculate a value of difference between the actual weight and the standard weight of the product; and
displaying a warning message if the value of difference for the product exceeds a predetermined value range set by a user.

8. The method of claim 7, wherein the product related information further comprises product number, standard weight of single product, and accessory weight.

9. The method of claim 8, wherein the standard weight of the product comprises at least one of the standard weight of single product and a standard weight of finished product, and the standard weight of finished product represents the sum of the standard weight of single product and the accessory weight.

10. The method of claim 7, wherein the actual weight of the product comprises at least one of an actual weight of single product and an actual weight of finished product.

11. (canceled)

12. The system of claim 2, wherein the data accessing module further stores the actual weight of the product into the product database to allow the user to search the actual weight.

13. The method of claim 7 further comprising storing the actual weight of the product into the product database to allow the user to search the actual weight.
